(19) United States
(12) Patent Application Publication
(10) Pub. No.: US 2014/0176378 A1
(43) Pub. Date: Jun. 26, 2014

(54) MULTI-BAND ANTENNA

(71) Applicants: Yen-Hao Yu, Taipei City (TW); Chieh-Tsao Hwang, Taipei City (TW); Shih-Chia Liu, Taipei City (TW)

(72) Inventors: Yen-Hao Yu, Taipei City (TW); Chieh-Tsao Hwang, Taipei City (TW); Shih-Chia Liu, Taipei City (TW)

(73) Assignee: COMPAL ELECTRONICS, INC., Taipei City (TW)

(21) Appl. No.: 14/074,649

(22) Filed: Nov. 7, 2013

Related U.S. Application Data
(60) Provisional application No. 61/745,806, filed on Dec. 25, 2012.

(51) Int. Cl. H01Q 5/00; H01Q 13/10

(52) U.S. Cl. CPC H01Q 5/001; H01Q 13/10
USPC 343/767

(57) ABSTRACT

A multi-band antenna including a metal plate and a radiation element is provided. The metal plate is electrically connected to a ground plane and has a slot. A resonant path is formed by the edges of the slot. The radiation element has a feeding point and is located in the slot of the metal plate. A feeding signal from the radiation element is coupled to the metal plate, and the multi-band antenna excites a resonant mode by the resonant path of the metal plate, so as to receive or transmit a first radio frequency signal.

### CROSS-REFERENCE TO RELATED APPLICATION

This application claims the priority benefits of U.S. provisional application Ser. No. 61/745,806, filed on Dec. 25, 2012. The entirety of the above-mentioned patent applications is hereby incorporated by reference herein and made a part of this specification.

### BACKGROUND OF THE INVENTION

1. Field of the Invention

The invention relates to an antenna, and more particularly to a multi-band antenna.

2. Description of Related Art

In wireless capable electronic devices nowadays, such as the notebook computer or the tablet computer, not only is the trend towards a thin and light outer appearance, but an exterior design with metal casing or other metallic materials are adopted to attract consumer attention.

However, although the metallic sense of the exterior design has preferable aesthetics and a more solid appearance, major challenges are presented for antenna design in the electronic device. For example, the configuration of conventional antennas typically must correspond to a clearance area with no metallic materials, and the clearance area is usually far larger than the size of the antenna. However, exterior designs having the metallic sense limits the clearance area needed by the antenna, and thus breakthroughs in the mechanical structure and exterior design of the electronic device remain stagnant.

### SUMMARY OF THE INVENTION

The invention provides a multi-band antenna utilizing the edges of a slot on a metal plate to form a resonant path, and a radiation element located in the slot is used to excite the resonant path on the metal plate. Accordingly, the clearance area needed by the antenna can be reduced while also considering the mechanical structure and the exterior design of the electronic device.

The multi-band antenna includes a metal plate and a radiation element. The metal plate is electrically connected to a ground plane and has a slot. A resonant path is formed by the edges of the slot. The radiation element has a feeding point and is located in the slot of the metal plate. Moreover, a feeding signal from the radiation element is coupled to the metal plate, and the multi-band antenna excites a resonant mode by the resonant path of the metal plate, so as to receive or transmit a first radio frequency signal.

According to an embodiment of the invention, the multi-band antenna further includes a substrate. The substrate is located in the slot of the metal plate, and the radiation element is disposed on the substrate.

According to an embodiment of the invention, the slot penetrates the metal plate, and the slot is a closed slot.

According to an embodiment of the invention, a total length of the edges of the slot is equal to a length of the resonant path, and the length of the resonant path is equal to a wavelength of the first radio frequency signal.

In summary, the multi-band antenna according to embodiments of the invention utilizes the edges of the slot on the metal plate to form a resonant path, and the radiation element located in the slot is used to excite the resonant path on the metal plate. Moreover, the size of the slot on the metal plate is related to the wavelength of the first radio frequency signal, and the slot forms the clearance area of the multi-band antenna. Therefore, in actual applications, the slot (i.e. clearance area) on the metal plate only needs to be slightly larger than the radiation element. Accordingly, the clearance area needed by the antenna can be reduced while also considering the mechanical structure and the exterior design of the electronic device.

To make the above features and advantages of the invention more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is an explosive view of a multi-band antenna according to an embodiment of the invention.

FIG. 2 is a schematic view of a multi-band antenna according to an embodiment of the invention.

FIG. 3 is a diagram illustrating the return loss of a multi-band antenna according to an embodiment of the invention.

FIG. 4 is a diagram of the antenna efficiency of a multi-band antenna according to an embodiment of the invention.

FIGS. 5 and 6 are the respective diagrams of the surface current distribution of a multi-band antenna when operating in a first frequency band and a second frequency band according to an embodiment of the invention.

FIGS. 7A-7D are schematic views of a multi-band antenna according to another embodiment of the invention.

### DESCRIPTION OF EMBODIMENTS

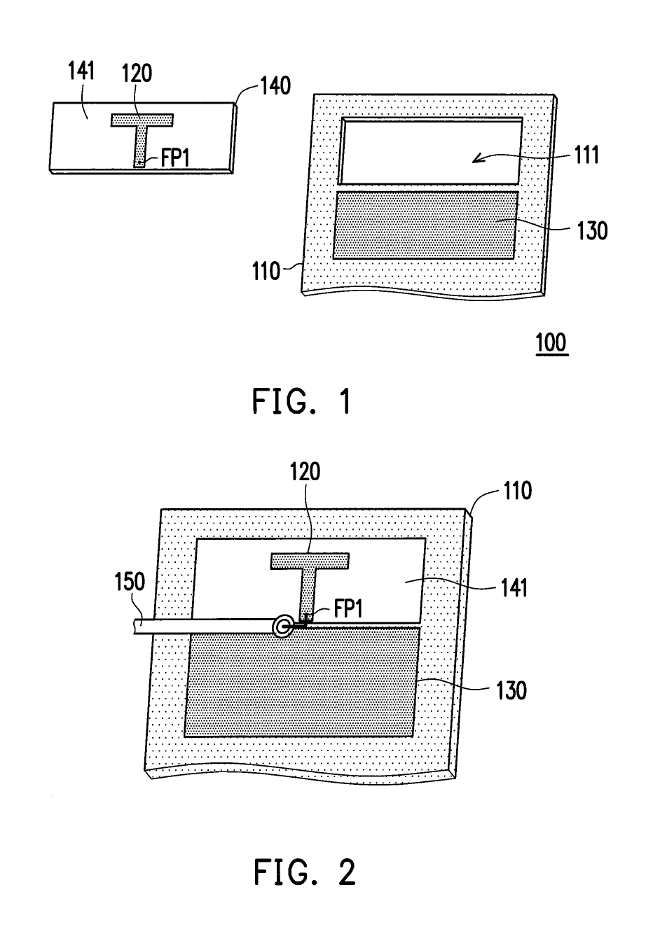

FIG. 1 is an explosive view of a multi-band antenna according to an embodiment of the invention. With reference to FIG. 1, a multi-band antenna 100 includes a metal plate 110, a radiation element 120, a ground plane 130, and a substrate 140. The metal plate 110 has a slot 111, and the slot 111 penetrates through the metal plate 110. Moreover, the metal plate 110 is electrically connected to the ground plane 130. For example, in the embodiment depicted by FIG. 1, the ground plane 130 is directly adhered on the metal plate 110, such that the metal plate 110 is electrically connected to the ground plane 130.

In addition, with regards to the overall configuration, the size of the substrate 140 is configured to correspond to the size of the slot 111 of the metal plate 110, such that the substrate 140 may be inserted in the slot 111. Moreover, the radiation element 120 is disposed on a surface 141 of the substrate 140. Accordingly, the radiation element 120 is positioned in the slot 111 of the metal plate 110 due to the disposition of the substrate 140. For example, FIG. 2 is a schematic view of a multi-band antenna according to an embodiment of the invention. As shown in FIG. 2, when the substrate 140 is inserted in the slot 111, the radiation element 120 and the substrate 140 are both positioned in the slot 111, and the ground plane 130 is located near the radiation element 120 in the slot 111.

With reference to FIGS. 1 and 2, the radiation element 120 has a feeding point FP1, and the edges of the slot 111 of the metal plate 110 form a resonant path. In operation, the multi-band antenna 100 receives a feeding signal via the feeding point FP1 of the radiation element 120. For example, in one embodiment, the multi-band antenna 100 further includes a coaxial wire 150, and an electronic device (not drawn) transmits the feeding signal to the feeding point FP1 of the radiation element 120 through the coaxial wire 150.

An internal conductor of the coaxial wire 150 is electrically connected to the feeding point FP1 of the radiation element 120, and an external conductor of the coaxial wire 150 is electrically connected to the ground plane 130. Moreover, the feeding signal from the radiation element 120 is coupled to the metal plate 110. Accordingly, the multi-band antenna 100 excites a resonant mode by the resonant path of the metal plate 110, so as to receive or transmit a first radio frequency signal. On the other hand, the radiation element 120 generates at least one resonant mode in response to excitation by the feeding signal, such that the multi-band antenna 100 may at least receive or transmit a second radio frequency signal through the radiation element 120.

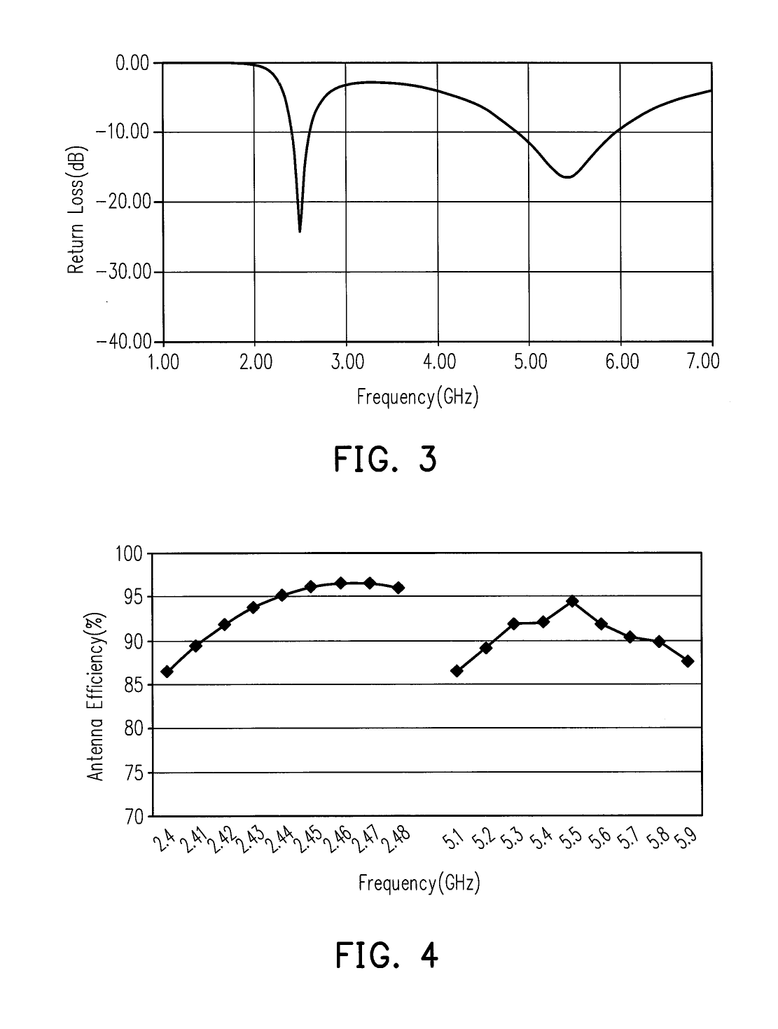

For example, FIG. 3 is a diagram illustrating the return loss of a multi-band antenna according to an embodiment of the invention, and FIG. 4 is a diagram of the antenna efficiency of a multi-band antenna according to an embodiment of the invention. As shown in FIG. 3, the multi-band antenna 100 receives or transmits the first radio frequency signal in a first frequency band (e.g. 2 GHz) through the metal plate 110. Moreover, the embodiment depicted in FIG. 1 exemplifies the radiation element 120 by a radiation body having a monopole antenna structure, and the radiation element 120 having the monopole antenna structure receives or transmits the second radio frequency signal in a second frequency band (e.g. 5 GHz). A frequency of the second radio frequency signal is greater than a frequency of the first radio frequency signal. As shown in FIG. 4, the antenna efficiency of the multi-band antenna 100 is higher than 85% when operating in the first frequency band (e.g. 2 GHz) and the second frequency band (e.g. 5 GHz).

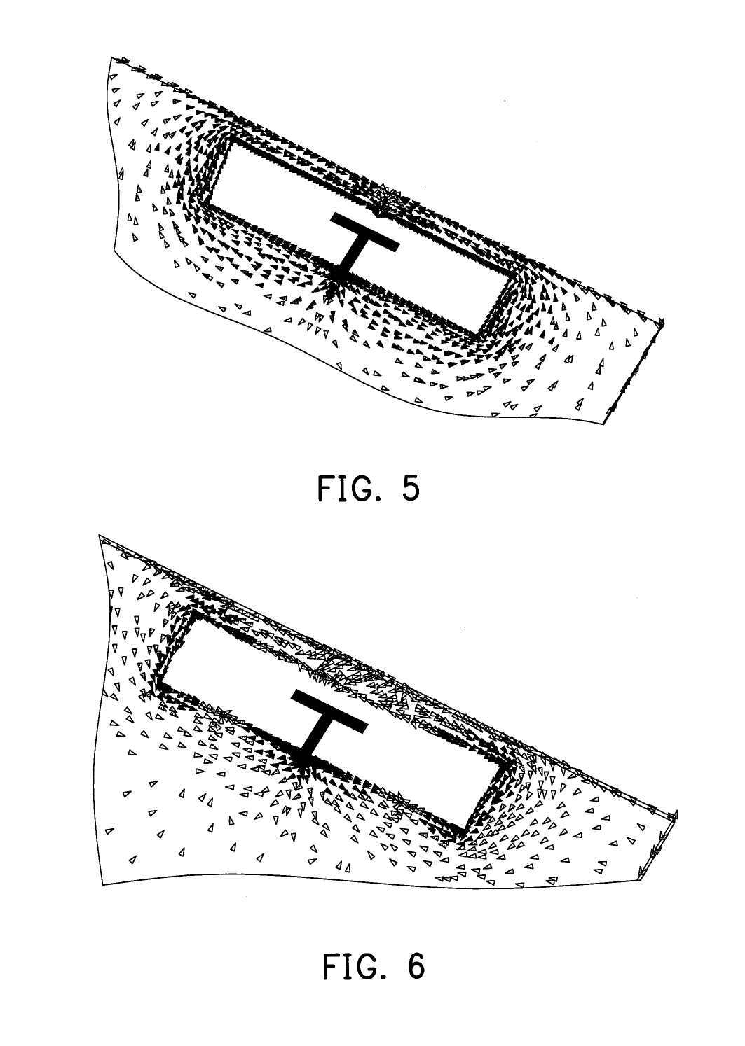

In addition, FIGS. 5 and 6 are the respective diagrams of the surface current distribution of a multi-band antenna when operating in a first frequency band and a second frequency band according to an embodiment of the invention. As shown in FIG. 5, when the multi-band antenna 100 is operated in the first frequency band (e.g. 2 GHz), the current of the multi-band antenna is concentrated on the edges of the slot 111 and the radiation element 120. Moreover, as shown in FIG. 6, when the multi-band antenna 100 is operated in the second frequency band (e.g. 5 GHz), the current of the multi-band antenna is concentrated on the radiation element 120. In other words, when operating in the first frequency band (e.g. 2 GHz), the multi-band antenna 100 excites the resonant path formed by the edges of the slot 111 by signal coupling, and the multi-band antenna 100 has preferable isolation.

It should be noted that, the slot 111 on the metal plate 110 is a closed slot. That is, the edges of the slot 111 are continuous and connect to one another without a break. Moreover, a total length of the edges of the slot 111 is equal to a length of the resonant path provided by the metal plate 110, and the length of the resonant path is equal to a wavelength of the first radio frequency signal. In other words, the size of the slot 111 of the metal plate 110 is related to the wavelength of the first radio frequency signal. Therefore, in actual applications, the slot 111 on the metal plate 110 only needs to be slightly larger than the radiation element 120. It should be also noted that, the slot 111 on the metal plate 110 forms the clearance area of the multi-band antenna 100. Therefore, compared to conventional techniques, the multi-band antenna 100 can efficiently reduce the clearance area needed by the antenna.

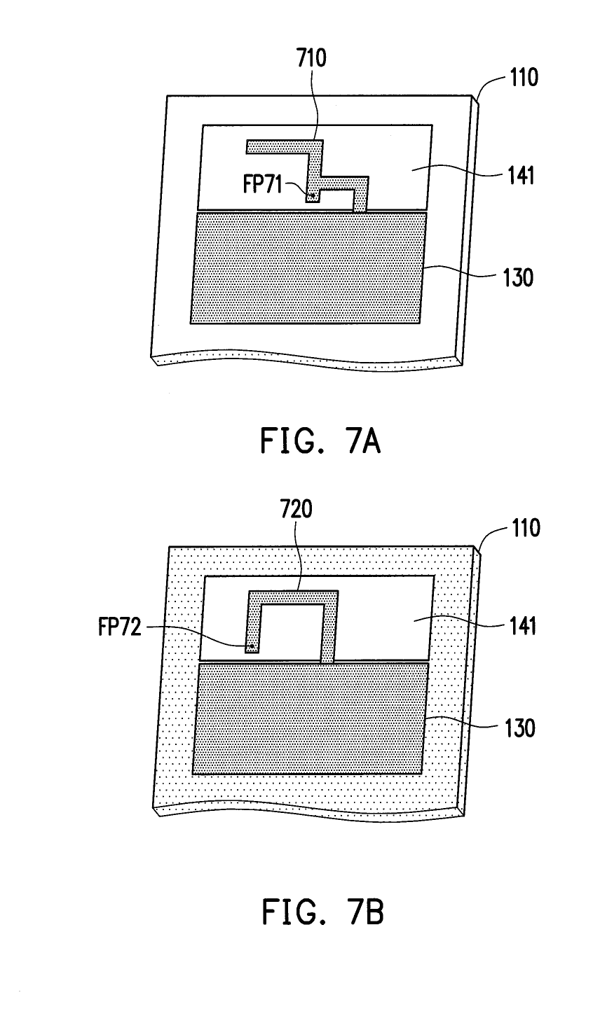

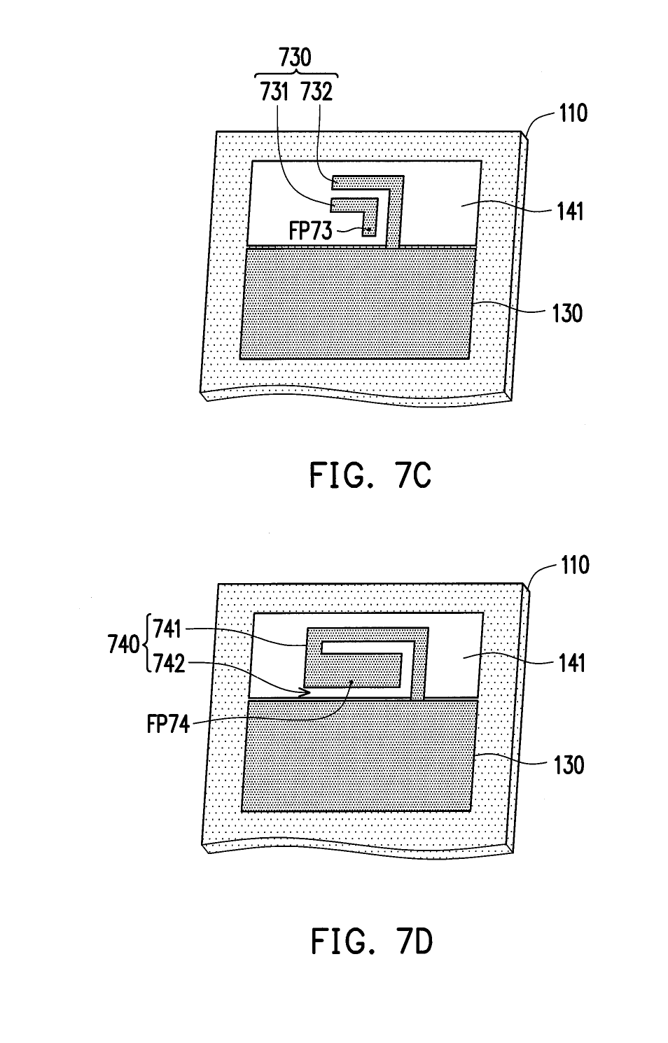

In addition, although the embodiment depicted in FIG. 1 exemplified the shape of the slot 111 as a rectangle, the embodiment should by no means limit the scope of the invention. For example, the shape of the slot 111 may also be geometric shapes such as a trapezoid, a parallelogram, and an oval. Furthermore, although the embodiment depicted in FIG. 1 exemplified the implementation of the radiation element 120, the embodiment should by no means limit the scope of the invention. For example, FIGS. 7A-7D are schematic views of a multi-band antenna according to another embodiment of the invention. As shown in FIG. 7A, a radiation element 710 is a radiation body having an inverted-F antenna structure and a feeding point FP71. Moreover, as shown in FIG. 7B, a radiation element 720 is a radiation body having a loop antenna structure and a feeding point FP72.

In addition, as shown in FIG. 7C, a radiation element 730 is a radiation body having a coupled antenna structure. In specifics, the radiation element 730 includes a body portion 731 and an extending portion 732. The body portion 731 has a feeding point FP73, and the extending portion 732 extends from the ground plane 130. Moreover, as shown in FIG. 7D, a radiation element 740 is a radiation body having a slot antenna structure. In specifics, the radiation element 740 includes a metal portion 741 and a recess 742. The metal portion 741 is electrically connected to the ground plane 130 and has a feeding point FP74. Additionally, the recess 742 penetrates the metal portion 741 and has an opening.

It should be noted that, the multi-band antenna 100 exemplified in the afore-described embodiments may be disposed in an electronic device, and the metal plate 110 may be a casing of the electronic device. For example, the electronic device may be a desktop computer, a notebook computer, a tablet computer, or a smart phone. For the desktop computer, the notebook computer, or the tablet computer, the metal plate 110 of the multi-band antenna 100 may be located in the metal back cover behind the display panel. On the other hand, for the smart phone, the metal plate 110 of the multi-band antenna 100 may be the metal casing of the smart phone.

In view of the foregoing, the multi-band antenna according to embodiments of the invention utilizes the edges of the slot on the metal plate to form a resonant path, and the radiation element located in the slot is used to excite the resonant path on the metal plate. Accordingly, the multi-band antenna is capable of not only generating a resonant mode by the resonant path on the metal plate, but also generating at least another resonant mode by the radiation element, thereby achieving multi-band operation. Moreover, the size of the slot on the metal plate is related to the wavelength of the first radio frequency signal, and the slot forms the clearance area of the multi-band antenna. Therefore, in actual applications, the slot (i.e. clearance area) on the metal plate only needs to be slightly larger than the radiation element. Accordingly, the clearance area needed by the antenna can be reduced while also considering the mechanical structure and the exterior design of the electronic device.

Although the invention has been described with reference to the above embodiments, it will be apparent to one of ordinary skill in the art that modifications to the described embodiments may be made without departing from the spirit of the invention. Accordingly, the scope of the invention will be defined by the attached claims and not by the above detailed descriptions.

What is claimed is:

1. A multi-band antenna, comprising:
a metal plate electrically connected to a ground plane, the metal plate having a slot, wherein a resonant path is formed by the edges of the slot; and
a radiation element having a feeding point and is located in the slot of the metal plate, wherein a feeding signal from the radiation element is coupled to the metal plate, and the multi-band antenna excites a resonant mode by the resonant path of the metal plate so as to receive or transmit a first radio frequency signal.

2. The multi-band antenna according to claim 1, further comprising:
a substrate located in the slot of the metal plate, wherein the radiation element is disposed on the substrate.

3. The multi-band antenna according to claim 1, wherein the ground plane is adhered on the metal plate.

4. The multi-band antenna according to claim 1, wherein the slot penetrates the metal plate, and the slot is a closed slot.

5. The multi-band antenna according to claim 1, wherein a total length of the edges of the slot is equal to a length of the resonant path.

6. The multi-band antenna according to claim 1, wherein a length of the resonant path is equal to a wavelength of the first radio frequency signal.

7. The multi-band antenna according to claim 1, wherein the multi-band antenna at least receives a second radio frequency signal through the radiation element, and a frequency of the second radio frequency signal is greater than a frequency of the first radio frequency signal.

8. The multi-band antenna according to claim 1, further comprising:
a coaxial wire, wherein an internal conductor of the coaxial wire is electrically connected to the feeding point of the radiation element, and an external conductor of the coaxial wire is electrically connected to the ground plane.

9. The multi-band antenna according to claim 1, wherein the multi-band antenna is disposed in an electronic device, and the metal plate is a casing of the electronic device.
